(19) United States
(12) Patent Application Publication
(10) Pub. No.: US 2005/0241681 A1
(43) Pub. Date: Nov. 3, 2005

(54) Nozzle assembly and dish washer having the same

(76) Inventor: Gap Kyu Hwang, Suseong-gu (KR)

Correspondence Address: MCKENNA LONG & ALDRIDGE LLP, 1900 K STREET, NW, WASHINGTON, DC, 20006, US

(21) Appl. No.: 11/038,425

(22) Filed: Jan. 21, 2005

(30) Foreign Application Priority Data
May 3, 2004 (KR) P 2004-30954

(51) Int. Cl. B08B 3/00

(52) U.S. Cl. 134/56 D; 134/58 D; 134/198

(57) ABSTRACT

A nozzle assembly easily assembled and a dish washer having the same are provided. The nozzle assembly includes a nozzle body and a shaft. The nozzle body is connected, in its upper portion, with the fluid guide for guiding fluid. The shaft is joined to the fluid guide to support a lower portion of the nozzle body.

This application claims the benefit of the Korean Application No. P2004-30954 field on May 3, 2004 which is hereby incorporated by reference.

### BACKGROUND OF THE INVENTION

1. Field of the Invention

The present invention relates to a dish washer, and more particularly, to a nozzle assembly provided to a dish washer, for spraying washing water.

2. Discussion of the Related Art

Generally, a dish washer is an electronic apparatus for spraying washing water pumped by a washing pump to a rack into which dishes are received using a spraying nozzle to wash and dry the dishes.

The dish washer includes a cabinet, a rack, a sump, a pump, and a nozzle assembly for spraying washing water.

Here, the cabinet constitutes an appearance of the dish washer and has a space for washing dishes formed in its inside.

The cabinet has the rack in its inside and the rack receives dishes which will be washed.

The sump is provided to a lower side of the cabinet to store washing water for washing the dishes received in the rack.

The pump connected with a motor sucks washing water stored in the sump using operation of the motor and pumps the washing water with a high pressure. The pumped washing water is sprayed to the dishes received in the rack by means of the nozzle assembly.

In the meantime, the nozzle assembly includes a nozzle body connected with a fluid guide of a washing water passage through which washing water pumped by the pump flows, for spraying washing water while rotating.

The nozzle body has a plurality of nozzles through which washing water is discharged. Further, the nozzle body is rotated by action-reaction principle of the washing water sprayed from the nozzle.

Here, since the nozzle assembly should be conveniently assembled, recently it is required to develop a nozzle assembly having a structure such that the fluid guide and the nozzle body are easily assembled.

### SUMMARY OF THE INVENTION

Accordingly, the present invention is directed to a nozzle assembly and a dish washer having the same that substantially obviate one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a nozzle assembly, which includes: a nozzle body whose upper portion is connected with a fluid guide for guiding fluid; and a shaft connected with the fluid guide, for supporting a lower portion of the nozzle body.

In another aspect of the present invention, there is provided a nozzle body, which includes: a cavity for passing through the nozzle body in an-up/down direction so that the shaft may be inserted from a lower side of the nozzle body and joined to the fluid guide; and a plurality of nozzles through which fluid is sprayed.

The shaft includes: a support for supporting a lower side of the nozzle body; and a shaft body inserted into the cavity of the nozzle body to be joined to the fluid guide and whose lower end is connected with the support.

Here, a front side of the support is wider than a lower end of the cavity formed on the nozzle body.

The nozzle assembly further includes at least one slip member provided at least on one side of either the support or the shaft body, perpendicularly to an axial direction of the shaft, constituting a slip plane so that the nozzle body may rotate.

At least the one slip member is provided between a front side of a step part formed on an upper portion of the shaft body and having an average radius smaller that an average radius of the support and a backside of a step part formed on an upper portion of the nozzle body.

At least the one slip member may be provided between a front side of the support and a lower edge of the cavity.

A joining protuberance is formed on one side of either the shaft or the fluid guide and a joining groove is formed on the other side.

The joining protuberance is formed on an outer surface of the shaft and the joining groove is formed on an inner surface of an end of the fluid guide.

The joining protuberance may be inclined in its surface that faces the fluid guide.

In the meantime, the nozzle body rotates to spray fluid.

In still another aspect of the present invention, there is provided a dish washer, which includes: a cabinet constituting an appearance; a rack for receiving dishes; and a nozzle assembly for spraying washing water for washing the dishes received in the rack, the nozzle assembly including a fluid guide for guiding the washing water, a nozzle body whose upper portion is connected with the fluid guide, for spraying the washing water while rotating, and a shaft joined to the fluid guide, for supporting a lower portion of the nozzle body.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating an inner construction of a dish washer to which a nozzle assembly according to an embodiment of the present invention;

FIG. 2 is a perspective view illustrating a state where a nozzle assembly is joined to a fluid guide according to an embodiment of the present invention; and

FIG. 3 is a longitudinal, cross-sectional view illustrating a state where a nozzle assembly is joined to a fluid guide according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

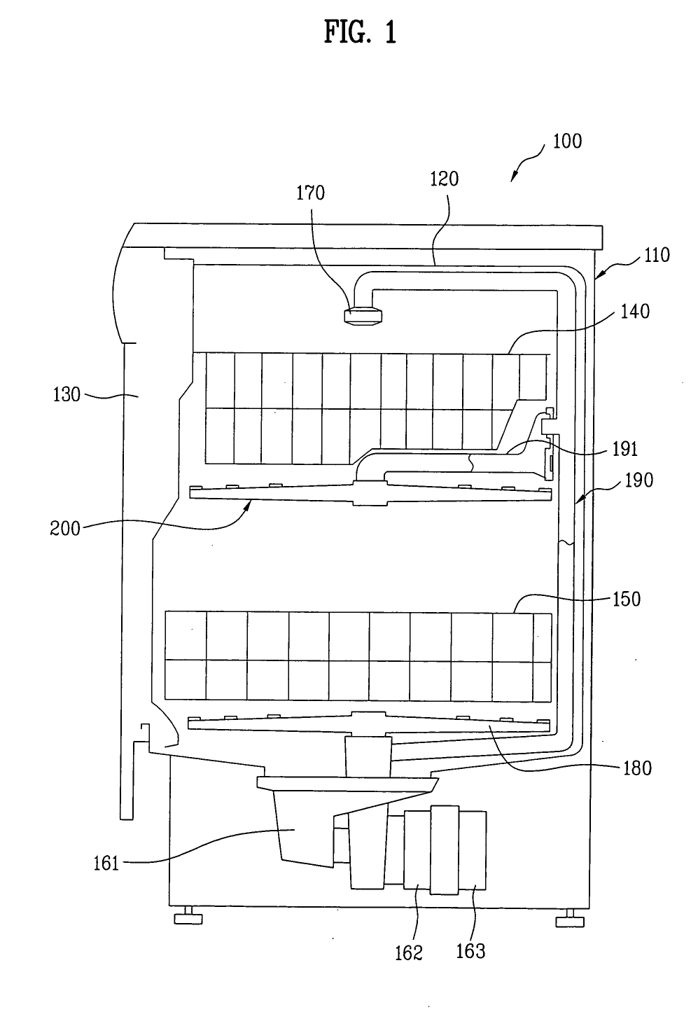

A dish washer having a nozzle assembly according to an embodiment of the present invention will be described in detail with reference to FIG. 1 in the following.

Referring to FIG. 1, the dish washer 100 includes: a cabinet 110 constituting an appearance; a tub 120 provided to an inside of the cabinet 110, for forming a dish washing space; and a door 130 provided to a front side of the cabinet in a detachable manner.

Here, at least one rack 140 and 150 for receiving dishes that will be washed is provided to an inside of the tub 120.

More specifically, an upper rack 140 for receiving dishes is provided to an upper space of the tub 120 and a lower rack 150 is provided below the upper rack 140.

Here, wheels (not shown) are provided to a backside of the upper and the lower racks 140 and 150. These wheels are supported by rails (not shown) provided to an inner side of the tub. 120. Accordingly, the racks 140 and 150 are moved back and forth by means of the wheels and the rails.

Further, a sump 161, a pump 162 connected with the sump 161, and a motor 163 for operating the pump 162 are provided to a lower portion of the tub 120.

Further, a top nozzle 170 is provided above the upper rack 140 and a nozzle assembly 200 according to the present invention is provided below the upper rack 140. A lower nozzle 180 is provided below the lower rack 150.

Here, the top nozzle 170, the nozzle assembly 200, and the lower nozzle 180 are connected with a washing water passage 190 through which washing water pumped from the pump 181 flows.

More specifically, the washing water passage 190 includes: a passage in up/down direction (not shown); and a fluid guide 191 whose one end is connected with the nozzle assembly 200, for guiding washing water.

Here, the fluid guide 191 horizontally guides the washing water flowing along a main body of the passage. One end of the fluid guide 191 connected with the nozzle assembly 200 has a shape bent downward.

Further, the top nozzle 170 sprays the washing water downward and the nozzle assembly 200 and the lower nozzle 180 spray the washing water upward.

More desirably, the nozzle assembly 200 is configured to spray the washing water downward, too.

With such a construction, the washing water stored in the sump 161 is pumped with a high pressure by means of the pump 162 connected with the motor 163. The washing water pumped with a high pressure in this manner flows along the washing water passage 190 and is sprayed from the top nozzle 170, the nozzle assembly 200, and the lower nozzle 180.

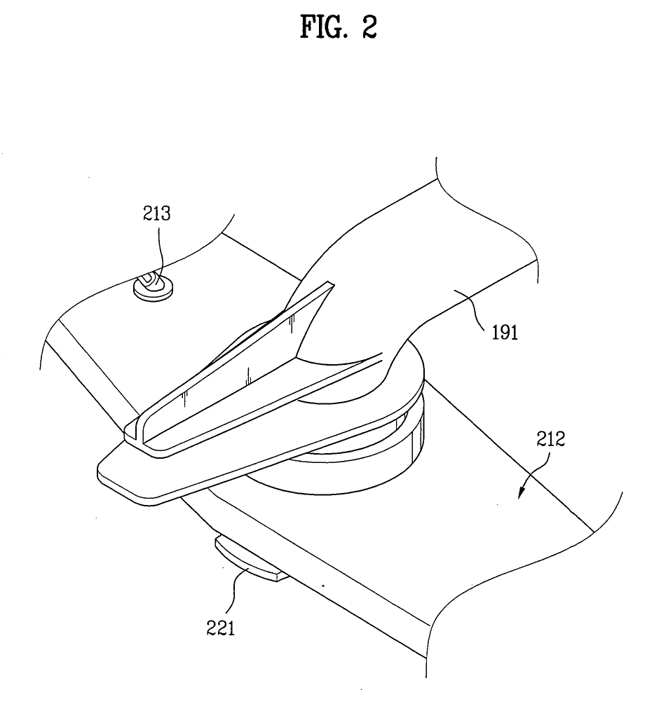

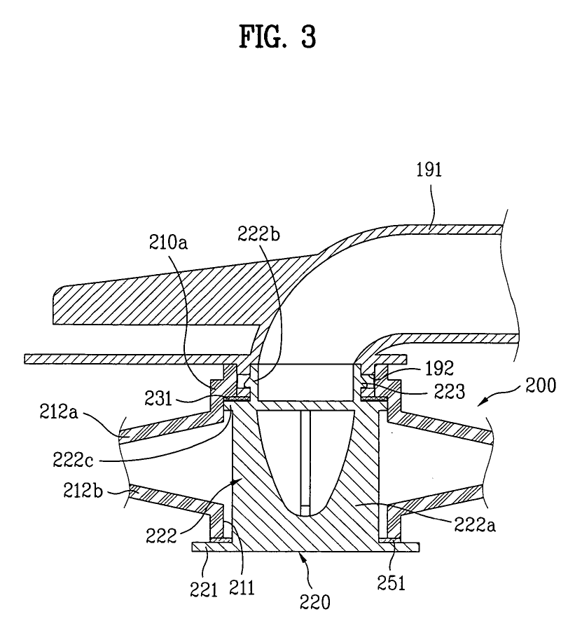

Next, a nozzle assembly will be described according to an embodiment of the present invention with reference to FIGS. 2 and 3.

Here, FIG. 2 is a perspective view illustrating a state where a nozzle assembly is joined to a fluid guide according to an embodiment of the present invention, and FIG. 3 is a longitudinal, cross-sectional view illustrating a state where a nozzle assembly is joined to a fluid guide according to an embodiment of the present invention.

Referring to FIGS. 2 and 3, the nozzle assembly 200 includes: a nozzle body 210 whose upper portion is connected with the fluid guide 191; and a shaft 220 joined to the fluid guide 191, for supporting a lower portion of the nozzle body 210.

The nozzle body 210 is connected with one end of the fluid guide 191, i.e., with a bent portion of the fluid guide 191 vertically.

Here, the nozzle body 210 includes: a cavity 211 for passing through a medium portion of the nozzle body 210 in up/down direction so that the shaft 220 may be inserted from a lower side of the nozzle body 210 and joined to the fluid guide 191; a nozzle arm 212 extended a predetermined length to both sides of the cavity 211; and a plurality of nozzles 213 through which washing water is sprayed.

The nozzle arm 212 includes an upper nozzle arm 212a forming a front side and a lower nozzle arm 212b forming a backside. The upper nozzle arm 212a and the lower nozzle arm 212b constitute a passages (not shown) through which the washing water supplied from the fluid guide 191 flows.

Therefore, the washing water supplied to an inside of the nozzle body 210 is sprayed through a plurality of nozzles 213 formed on the front side and the backside of the nozzle arm 212.

One end of the fluid guide 191 is inserted into and connected with an upper end of the cavity at an upper portion of the nozzle body 210.

Next, the shaft 220 is inserted into the cavity 211 and connected with one end of the fluid guide 191 at a lower portion of the nozzle body 210. The shaft 220 includes: a support 221 for supporting a lower portion of the nozzle body 210; and a shaft body 222 inserted into the cavity of the nozzle body 210 and joined to the fluid guide 191 and whose lower end is connected with the support 221.

Here, the support 221 is formed greater in its size than a lower inner diameter of the cavity 211 formed on the nozzle body 210 so as to support a lower rim of the cavity 211.

For that purpose, the support 221 may be formed in a variety of shapes. For example, the support 221 may be formed in an approximate quadrangular shape or a circular shape.

Further, a knob groove (not shown) may be formed on a backside of the support 221 so that a user may easily grasp the shaft 220.

Next, the shaft body 222 is configured such that the washing water supplied from the fluid guide 191 may flow into a passage formed in an inside of the nozzle body 210.

In the meantime, the nozzle assembly 200 further includes at least one slip member 231 and 232 provided perpendicularly to an axial direction of the shaft 220, at least on one side of either the support 221 or the shaft body 222, for forming a slip plane so that the nozzle body 210 may rotate.

At least the one slip member 231 and 232 may be provided between a front side of a step part formed on an upper portion of the shaft body 222 and having an average radius smaller than an average radius of the support 221 and a backside of a step part formed on an upper portion of the nozzle body 210, and/or between a front side of the support 221 and a lower rim of the cavity 211.

More specifically, the shaft body 222 includes: a middle body 222a whose lower end is integrally connected with the support 221 and having an upper end of a circular plate shape; and a connection part 222b of a cylindrical shape integrally formed on a front side of the middle body 222a.

Here, the middle body 222a has a circular protuberance radially protruded on its upper outer periphery and an outer diameter of the circular protuberance may be smaller than a lower inner diameter of the cavity 211.

Further, since an outer diameter of the connection part 222b is smaller than an outer diameter of an upper outer diameter of the middle body 222a, a step part 222c is formed on an upper portion of the shaft body 222 by the middle body 222a and the connection part 222b, and a front side of the step part 222c is formed by a front side of the middle body 222a and a front side of the circular protuberance.

Further, a step part 210a of the nozzle body 210 that corresponds to the step part 222c of the shaft body is formed on an upper portion of the nozzle body 210, more specifically, on an upper rim of the cavity 211 and supported by the step part 222c of the shaft body 222.

In the present embodiment, the slip member 231 provided between the step part 222c of the shaft body 222 and the step part 210a of the nozzle body 210 forms an upper slip plane. The slip member 232 provided between the support 221 and the lower rim of the cavity 211 forms a lower slip plane.

Of course, for rotation of the nozzle body 210, a bearing member (not shown) may be used instead of the slip members 231 and 232.

For joining of the shaft 220 and the fluid guide 191, a joining protuberance 223 is formed on one side of either the shaft 220 or the fluid guide 191 and a joining groove 192 for receiving the joining protuberance 223 is formed on the other side.

In the present embodiment, the joining protuberance 223 is formed on an outer periphery of the shaft 220, particularly, on an outer periphery of the connection part and the joining groove 192 is formed on an inner periphery of an end of the fluid guide 191 inserted into the cavity 211 of the nozzle body 210.

Here, the joining protuberance 223 may be inclined in its surface that faces the fluid guide 191.

In the meantime, the nozzle body 210 rotates to spray fluid. More specifically, the nozzle body 210 is rotated by the washing water sprayed from the nozzle 213.

It is obvious that a connecting structure for the above-described nozzle assembly 200 and the washing water passage can be applied to connection of the top nozzle 170 with the lower nozzle 180.

In assembly process for the nozzle assembly, if the shaft 220 having the slip members 231 and 232 is inserted into the cavity 211 from a lower side of the nozzle body 210 first, the slip members 231 and 232 provided to the support 221 and the step part 222c of the shaft are touched to the lower rim of the cavity 211 and the step part of the nozzle body 210, respectively.

Next, if one end of the fluid guide 191 is inserted into an upper portion of the cavity 211 from a front side of the nozzle body 210 so that the fluid guide 191 and the shaft 220 are pushed respectively, the connection part 222b of the shaft is inserted into one end of the fluid guide 191 and the joining protuberance 223 is hooked at the joining groove 192.

Accordingly, the nozzle assembly 200 is rotatably connected with the fluid guide 191.

Of course, the fluid guide 191 may be joined to the shaft 220 by connecting the fluid guide 191 with the nozzle body 210 first and inserting the shaft 220 into the nozzle body 210, applying pressure appropriately.

With the shaft 220 fixed to the fluid guide 191 as described above, if washing water is supplied to the nozzle body 210, the nozzle body 210 is rotated by action-reaction principle of the sprayed washing water. During this process, a slip phenomenon is generated between the nozzle body 210 and the slip members 231 and 232.

In operation of the dish washer having the above-described nozzle assembly 200, a user opens the door 130 of the dish washer 100 and draws out the upper rack 140 and/or the lower rack 150 to a front side of the cabinet 110.

Dishes are received in the upper rack 140 and/or the lower rack 150, the door 130 is closed, and then a power is applied to the dish washer 100.

If the power is applied to the dish washer 100 as described above, the dish washer 100 performs washing operation.

If the washing operation starts, washing water flows into the sump 161. If flowing of the washing water is completed, the motor 163 is operated.

After that, an impeller (not shown) provided to an inside of the pump 162 and connected to the motor 163 is rotated by operation of the motor 163, so that the washing water stored in the sump 161 is pumped and supplied, along the washing water passage 190, to the top nozzle 170, the nozzle assembly 200, and the lower nozzle 180.

Next, the washing water is sprayed to the upper rack 140 and the lower rack 150 through the top nozzle 170, the nozzle assembly 200, and the lower nozzle 180 to wash the dishes received in the upper and the lower racks 140 and 150.

Here, the top nozzle 170 sprays the washing water downward and the nozzle assembly 200 rotates to spray the washing water both up and down directions, and the lower nozzle 180 sprays the washing water upward.

If the washing operation is completed, contaminated washing water that has performed washing the dishes is gathered and the gathered contaminated washing water is deprived of its impurities by a filter (not shown) and then discharged to an outside of the dish washer through a discharging pump (not shown).

Further, if the washing water is discharged to the outside of the dish washer 100, clean washing water is supplied again to the sump 161 through a washing water inlet (not shown). After that, the described washing operation is performed repeatedly and rinsing operation is performed.

If the rinsing operation is completed, drying operation is finally performed, whereby dish washing is completed.

The nozzle assembly and the dish washer having the same provide the following effects.

First, according to the nozzle assembly of the present invention, the nozzle body and the fluid guide are easily assembled and thus productivity is improved.

Second, according to the nozzle assembly of the present invention, the slip members constituting the upper slip plane and the lower slip plane distribute frictional force generated upon rotation of the nozzle body, thereby minimizing abrasion of the nozzle body.

Third, according to the nozzle assembly of the present invention, an average radius of the upper slip plane is reduced, so that repulsive force with respect to rotational force of the nozzle body is minimized.

It will be apparent to those skilled in the art that various modifications and variations can be made in the present invention. Thus, it is intended that the present invention covers the modifications and variations of this invention provided they come within the scope of the appended claims and their equivalents.

1. A nozzle assembly comprising:
a nozzle body whose upper portion is connected with a fluid guide for guiding fluid; and
a shaft connected with the fluid guide, for supporting a lower portion of the nozzle body.

2. The nozzle assembly of claim 1, wherein the nozzle body comprises:
a cavity for passing through the nozzle body in an up/down direction so that the shaft is inserted from a lower side of the nozzle body and joined to the fluid guide; and
a plurality of nozzles through which fluid is sprayed.

3. The nozzle assembly of claim 2, wherein the shaft comprises:
a support for supporting a lower side of the nozzle body; and
a shaft body inserted into the cavity of the nozzle body to be joined to the fluid guide and whose lower end is connected with the support.

4. The nozzle assembly of claim 3, wherein a front side of the support is wider than a lower end of the cavity formed on the nozzle body.

5. The nozzle assembly of claim 3, further comprising:
at least one slip member provided at least on one side of either the support or the shaft body, perpendicularly to an axial direction of the shaft, and constituting a slip plane so that the nozzle body can rotate.

6. The nozzle assembly of claim 5, wherein at least the one slip member is provided between a front side of a step part formed on an upper portion of the shaft body and having an average radius smaller that an average radius of the support and a backside of a step part formed on an upper portion of the nozzle body.

7. The nozzle assembly of claim 5, wherein at least the one slip member is provided between a front side of the support and a lower edge of the cavity.

8. The nozzle assembly of claim 1, wherein a joining protuberance is formed on one side of either the shaft or the fluid guide and a joining groove is formed on the other side.

9. The nozzle assembly of claim 8, wherein the joining protuberance is formed on an outer surface of the shaft and the joining groove is formed on an inner surface of an end of the fluid guide.

10. The nozzle assembly of claim 9, wherein the joining protuberance is inclined in its surface that faces the fluid guide.

11. The nozzle assembly of claim 1, wherein the nozzle body rotates to spray fluid.

12. A dish washer comprising:
a cabinet constituting an appearance;
a rack for receiving dishes; and
a nozzle assembly for spraying washing water for washing the dishes received in the rack, the nozzle assembly including a nozzle body connected with a fluid guide for guiding washing water, for rotating to spray the washing water, and a shaft joined to the fluid guide, for supporting a lower portion of the nozzle body.

13. The dish washer of claim 12, wherein the nozzle body comprises:
a cavity for passing through the nozzle body in an up/down direction so that the shaft is inserted from a lower side of the nozzle body and joined to the fluid guide; and
a plurality of nozzles through which fluid is sprayed.

14. The dish washer of claim 13, wherein the shaft comprises:
a support for supporting a lower side of the nozzle body; and
a shaft body inserted into the cavity of the nozzle body to be joined to the fluid guide and whose lower end is connected with the support.

15. The dish washer of claim 14, wherein a front side of the support is wider than a lower end of the cavity formed on the nozzle body.

16. The dish washer of claim 14, further comprising:
at least one slip member provided at least on one side of either the support or the shaft body, perpendicularly to an axial direction of the shaft, and constituting a slip plane so that the nozzle body can rotate.

17. The dish washer of claim 16, wherein at least the one slip member is provided between a front side of a step part formed on an upper portion of the shaft body and having an average radius smaller that an average radius of the support and a backside of a step part formed on an upper portion of the nozzle body.

18. The dish washer of claim 16, wherein at least the one slip member is provided between a front side of the support and a lower edge of the cavity.

19. The dish washer of claim 12, wherein a joining protuberance is formed on one side of either the shaft or the fluid guide and a joining groove is formed on the other side.

20. The dish washer of claim 19, wherein the joining protuberance is formed on an outer surface of the shaft and the joining groove is formed on an inner surface of an end of the fluid guide.

21. The dish washer of claim 20, wherein the joining protuberance is formed on an outer surface of the shaft and inclined in its surface that faces the fluid guide.

22. The dish washer of claim 12, wherein the nozzle body has a knob for grasping formed on its lower side.
